(19) United States
(12) Patent Application Publication
(10) Pub. No.: US 2021/0104805 A1
(43) Pub. Date: Apr. 8, 2021

(54) BATTERY ASSEMBLY, AUTONOMOUS MOVABLE PLATFORM, AND AUTONOMOUS MOVABLE PLATFORM SYSTEM

(71) Applicant: SZ DJI TECHNOLOGY CO., LTD., Shenzhen (CN)

(72) Inventors: Dongan WU, Shenzhen (CN); Rongming XIONG, Shenzhen (CN); Yin TANG, Shenzhen (CN)

(21) Appl. No.: 17/123,733

(22) Filed: Dec. 16, 2020

Related U.S. Application Data
(63) Continuation of application No. PCT/CN2018/092864, filed on Jun. 26, 2018.

(51) Int. Cl. H01M 50/569; B64C 39/02; B60L 50/64; B64D 27/24; B60L 58/10; H01M 50/249; H01M 50/264

(52) U.S. Cl. CPC H01M 50/569; B64C 39/024; B60L 50/64; B64D 27/24; B60L 58/10; H01M 2220/20; H01M 50/264; B64C 2201/027; B64C 2201/042; B60L 2200/10; H01M 50/249

(57) ABSTRACT

A battery assembly includes a battery body, a housing, a switch assembly, an output terminal, and a snap clip assembly. The housing includes an accommodation chamber. The battery body is mounted in the accommodation chamber. The switch assembly is fixed at the housing and configured to generate an in-position signal. The output terminal is arranged at the housing and configured to output power of the battery body and the in-position signal. The snap clip assembly is arranged at the housing and configured to cause the switch assembly to be in a first status when no external force is applied to the snap clip assembly, the in-position signal being at a first level in the first status, and when an external force is applied to the snap clip assembly, cause the switch assembly to be in a second status, the in-position signal being at a second level in the second status.

### CROSS-REFERENCE TO RELATED APPLICATIONS

This application is a continuation of International Application No. PCT/CN2018/092864, filed Jun. 26, 2018, the entire content of which is incorporated herein by reference.

### TECHNICAL FIELD

The present disclosure generally relates to the autonomous movable platform technology field and, more particularly, to a battery assembly, an autonomous movable platform, and an autonomous movable platform system.

### BACKGROUND

An autonomous movable platform is usually powered by a detachable battery. The battery needs to be mounted before an operation of the autonomous movable platform. The existing battery and the autonomous movable platform lack a way to detect whether the battery is mounted in position. After the battery is mounted at the autonomous movable platform, a situation may occur that, although the battery contacts the autonomous movable platform and provides the power, the battery is actually not mounted in position. In this situation, the risk of the battery powering off and even falling off may occur during the operation of the autonomous movable platform, which poses a great threat to the safety of the autonomous movable platform.

### SUMMARY

Embodiments of the present disclosure provide a battery assembly includes a battery body, a housing, a switch assembly, an output terminal, and a snap clip assembly. The housing includes an accommodation chamber. The battery body is mounted in the accommodation chamber. The switch assembly is fixed at the housing and configured to generate an in-position signal. The output terminal is arranged at the housing and configured to output power of the battery body and the in-position signal. The snap clip assembly is arranged at the housing and configured to cause the switch assembly to be in a first status when no external force is applied to the snap clip assembly, the in-position signal being at a first level in the first status, and when an external force is applied to the snap clip assembly, cause the switch assembly to be in a second status, the in-position signal being at a second level in the second status.

Embodiments of the present disclosure provide an autonomous movable platform comprising a platform body including a battery compartment. The battery compartment is configured to accommodate a battery assembly. The battery assembly includes a battery body, a housing, a switch assembly, an output terminal, and a snap clip assembly. The housing includes an accommodation chamber. The battery body is mounted in the accommodation chamber. The switch assembly is fixed at the housing and configured to generate an in-position signal. The output terminal is arranged at the housing and configured to output power of the battery body and the in-position signal. The snap clip assembly is arranged at the housing and configured to cause the switch assembly to be in a first status when no external force is applied to the snap clip assembly, the in-position signal being at a first level in the first status, and when an external force is applied to the snap clip assembly, cause the switch assembly to be in a second status, the in-position signal being at a second level in the second status.

Embodiments of the present disclosure provide an autonomous movable platform system including a control terminal and an autonomous movable platform. The autonomous movable platform includes a platform body. The platform body includes a battery compartment configured to accommodate a battery assembly. The battery assembly includes a battery body, a housing, a switch assembly, an output terminal, and a snap clip assembly. The housing includes an accommodation chamber. The battery body is mounted in the accommodation chamber. The switch assembly is fixed at the housing and configured to generate an in-position signal. The output terminal is arranged at the housing and configured to output power of the battery body and the in-position signal. The snap clip assembly is arranged at the housing and configured to cause the switch assembly to be in a first status when no external force is applied to the snap clip assembly, the in-position signal being at a first level in the first status, and when an external force is applied to the snap clip assembly, cause the switch assembly to be in a second status, the in-position signal being at a second level in the second status.

### BRIEF DESCRIPTION OF THE DRAWINGS

FIG. 1 is a schematic side view of a battery assembly according to some embodiments of the present disclosure.

FIG. 2 is a schematic structural diagram showing a housing of the battery assembly shown in FIG. 1.

FIG. 3A is a schematic structural diagram showing a part of a structure including a switch assembly of the battery assembly shown in FIG. 1.

FIG. 3B is another schematic structural diagram showing the housing of the battery assembly shown in FIG. 1.

FIG. 4 is a schematic structural diagram showing a snap clip assembly of the battery assembly shown in FIG. 1.

FIGS. 5A, 5B, and 5C are schematic structural diagrams showing a top view, a side view, and a cross-sectional view along an A-A direction, respectively, of the battery assembly before being mounted according to some embodiments of the present disclosure.

FIGS. 6A, 6B, and 6C are schematic structural diagrams showing a top view, a side view, and a cross-sectional view along the A-A direction, respectively, of the battery assembly during being mounted according to some embodiments of the present disclosure.

FIGS. 7A, 7B, and 7C are schematic structural diagrams showing a top view, a side view, and a cross-sectional view along the A-A direction of the battery assembly after being mounted in position according to some embodiments of the present disclosure.

FIG. 8 is a schematic structural diagram of an unmanned aerial vehicle (UAV) without the battery assembly according to some embodiments of the present disclosure.

FIG. 9 is a schematic structural diagram of a UAV with the battery assembly mounted in position according to some embodiments of the present disclosure.

### REFERENCE NUMERALS

1—Battery body
2—Housing; 21—Bottom plate; 22—Side plate; 221—Opening; 23—Accommodation chamber; 24—Lightboard; 25—Flexible circuit board; 26—Motherboard;
3—Switch assembly; 31—Circuit board; 32—Switch;
4—Snap clip assembly; 41—Fixing member; 411—Through-hole; 42—Snap clip member; 421—Snap clip; 422—Compressing member; 423—Compressing piece; 424—Connection plate; 4211—Snap hook; 43—Connector;
5—Output terminal;
6—Platform body;
7—Battery compartment; 71—Bottom wall; 72—Sidewall; 73—Snap slot;
8—Battery switch; 81—Switch button; 82—Display;
10—Battery assembly;
211—First mounting member; 212—Second mounting member.

### DETAILED DESCRIPTION OF THE EMBODIMENTS

The present disclosure provides a battery assembly including a battery body, a housing, a switch assembly, an output terminal, and a snap clip assembly. An accommodation chamber may be formed at the housing. The battery body may be mounted in the accommodation chamber. The switch assembly may be fixed at the housing and generate an in-position signal. The output terminal may be arranged at the housing and configured to output the power of the battery body and the in-position signal. When no external force is applied at the snap clip assembly, the switch assembly may be in a first status and cause the in-position signal to maintain at a first level in the first status. When the external force is applied at the snap clip assembly, the snap clip assembly may cause the switch assembly to be in a second status. The in-position signal may be changed to a second level in the second status. The battery assembly of the present disclosure may provide power to any type of autonomous movable platform. The Autonomous movable platform may include but be not limited to an unmanned aerial vehicle (UAV), an unmanned vehicle, etc.

To make the purpose, the technical solution, and the advantage of the present disclosure clearer, the present disclosure is further described in detail in connection with specific embodiments and accompanying drawings.

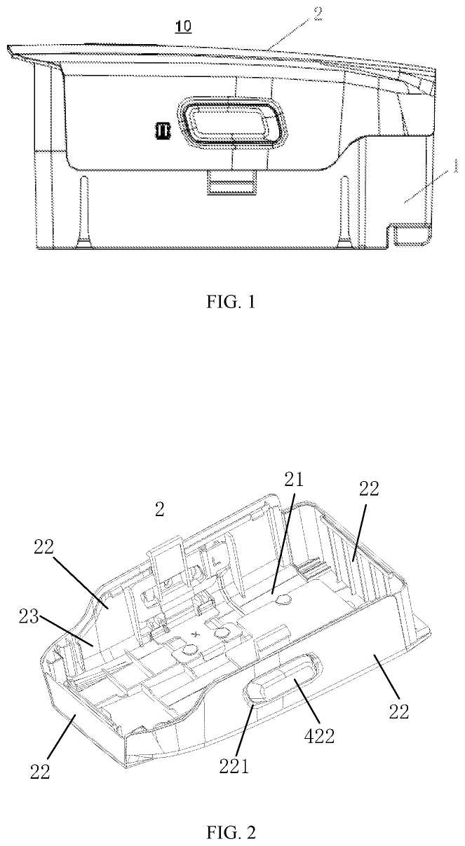

Embodiments of the present disclosure provide a battery assembly 10. As shown in FIG. 1, the battery assembly 10 includes a housing 2 and a battery body 1 mounted at the housing 2.

The battery body 1 is configured to supply power to the autonomous movable platform.

In some embodiments, as shown in FIG. 2, the housing 2 is a semi-closed structure formed by a bottom plate 21 and four side plates 22. The bottom plate 21 and the four side plates 22 enclose to form an accommodation chamber 23. The battery body 1 is fixed in the accommodation chamber 23. Two openings 221 are arranged at two opposite side plates 22 of the housing 2.

The housing 2 is arranged with the switch assembly, the snap clip assembly, and the output terminal. The switch assembly may be configured to be fixed at the housing 2, be electrically connected to the battery body 1, and generate the in-position signal. The snap clip assembly may be configured to compress the switch assembly to cause the in-position signal to maintain at the first level. When the external force is applied at the snap clip assembly, the snap clip assembly may release the switch assembly to cause the in-position signal to change to the second level. When the external force applied to the snap clip assembly is removed, the snap clip assembly may return to compress the switch assembly to cause the in-position signal to return to the first level. The output terminal may be configured to be electrically connected to the autonomous movable platform by using a connector to output the power of the battery body 1 and the in-position signal to the autonomous movable platform.

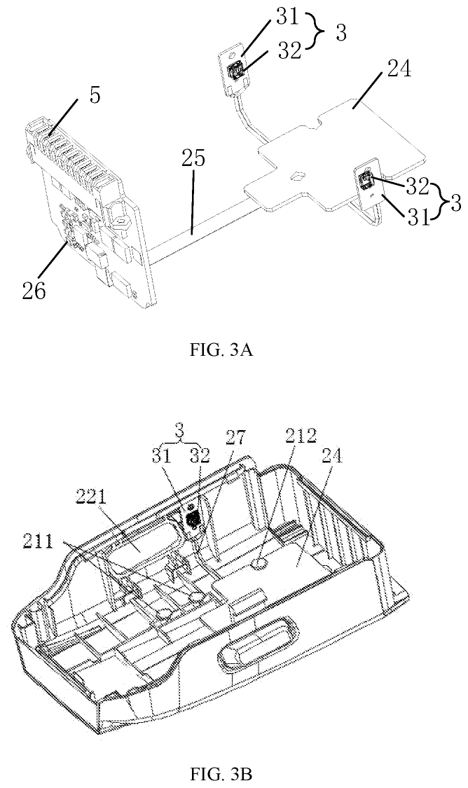

In some embodiments, as shown in FIGS. 3A and 3B, the switch assembly 3 includes a circuit board 31. The circuit board 31 includes a switch 32. The circuit board 31 is fixed at an inner wall of the side plate 22. The switch 32 may be configured to generate the in-position signal. A lightboard 24, a flexible circuit board 25, and a motherboard 26 are arranged in the housing 2. In some embodiments, the circuit board 31 of the switch assembly 3 may be electrically connected to the output terminal 5 through the lightboard 24, the flexible circuit board 25, and the motherboard 26 in sequence to transmit the in-position signal generated by the switch 32 to the output terminal 5. The circuit board 31 of the switch assembly 3 may be electrically connected to the lightboard 24 through a conductive wire 27.

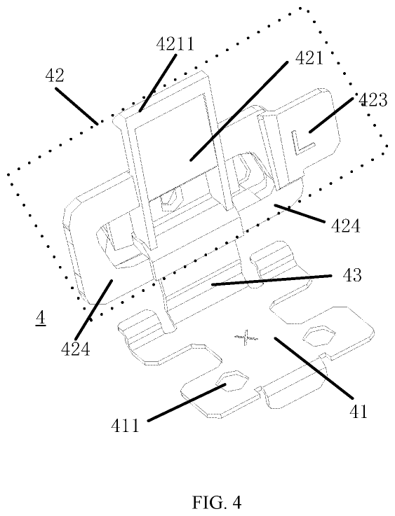

Referring to FIG. 2 and FIG. 4, the snap clip assembly 4 includes a fixing member 41, a connector 43, and a snap clip member 42. The connector 43 connects between the fixing member 41 and the snap clip member 42. A pair of through-holes 411 are formed at the fixing member 41. The fixing member 41 may be fixed at the bottom plate 21 of the housing by screws and the through-holes 411. A first mounting member 211 corresponding to the through-hole 411 is arranged at the bottom plate 21. The first mounting member 211 may be a threaded hole. The snap clip member 42 may move relative to the fixing member 41 under an external force to compress or release the switch 32. The snap clip member 42 includes a snap clip 421, a compressing member 422, a compressing piece 423, and a connection plate 424. The snap clip 421 is connected to the fixing member 41. The connection plate 424 is formed at the snap clip 421. The compressing member 422 is arranged at the connection plate 424 and is formed by being recessed facing an outer side of the housing 2. The compressing piece 423 is connected to the snap clip 421 through the connection plate 424. The compressing piece 423 may compress and release the switch 32. The compressing member 422 may correspond to the position of the opening 221 of the side plate of the housing and pass through the opening 221.

In some embodiments, the fixing member 41 and the snap clip member 42 may both be formed using a hard material. The connector 43 may need to be elastic, such that the snap clip member 42 may move relative to the fixing member 41. The fixing member 41 may include, for example, a metal material, to ensure the fixation of the snap clip assembly 4. The connector 43 may include, for example, a metal piece, to have a certain elasticity. The connector 43 and the fixing member 41 may be formed integrally. The snap clip 42 may include, for example, a plastic material, to cause the snap clip member 42 to have a certain elasticity while maintaining a certain strength. Thus, the snap clip member 42 may not deform to cause misreporting or underreporting of the in-position signal. The snap clip 421, the compressing member 422, the compressing piece 423, and the connection plate 424 may be formed integrally. Since the connector 43 has the elasticity, the whole snap clip member 42 may have elasticity relative to the fixing member 41, such that the snap clip member 42 may move inward or outward relative to the housing 2.

As the snap clip 421, a bottom end of the snap clip 421 is connected to the fixing member 41, and a snap hook 4211 is formed at a top end of the snap clip 421. The height of the snap clip 421 is higher than the height of the side plate 22 of the housing. The height may refer to a length perpendicular to the bottom plate 21 of the housing. That is, the snap hook 4211 protrudes from the side plate 22 of the housing along a direction away from the bottom plate 21 of the housing. As such, when the battery assembly 10 is mounted at the autonomous movable platform, the battery assembly 10 and the autonomous movable platform may be fixed together through the snap hook 4211.

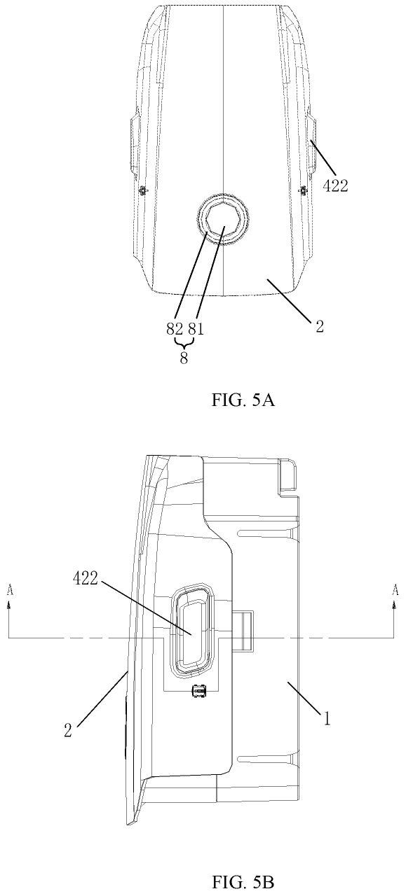

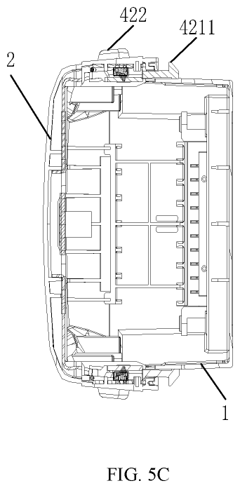

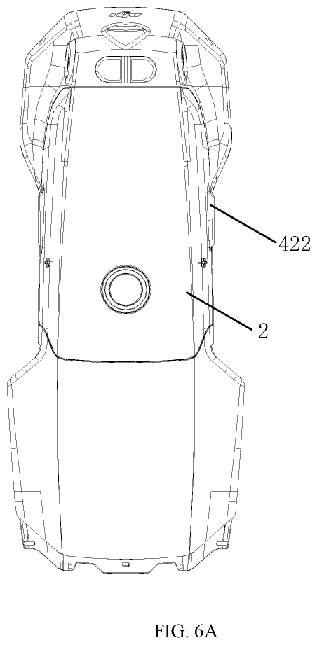

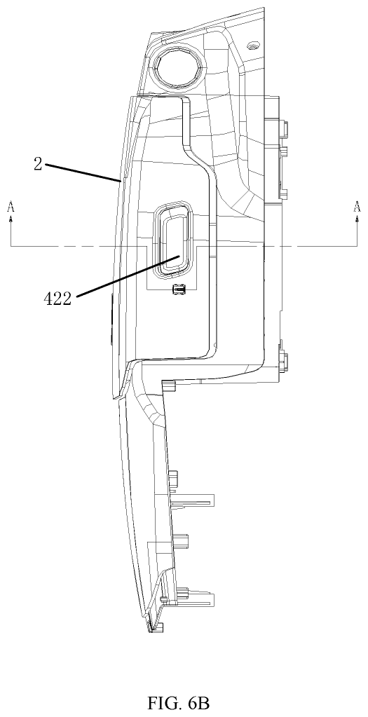

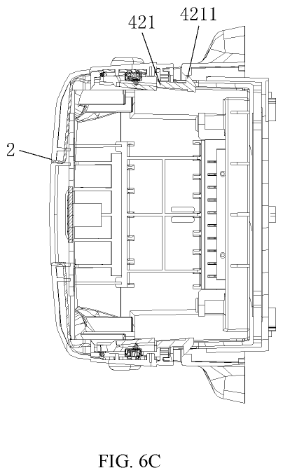

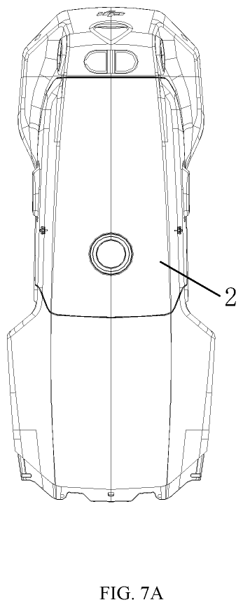

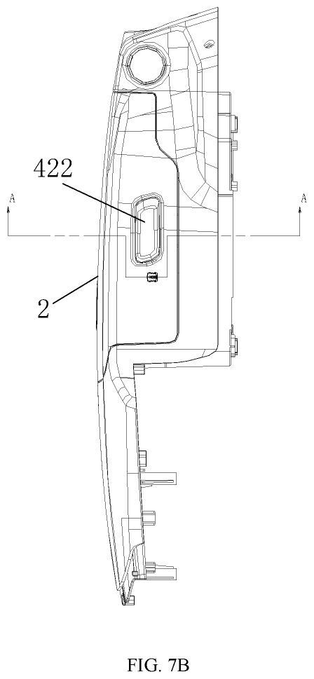

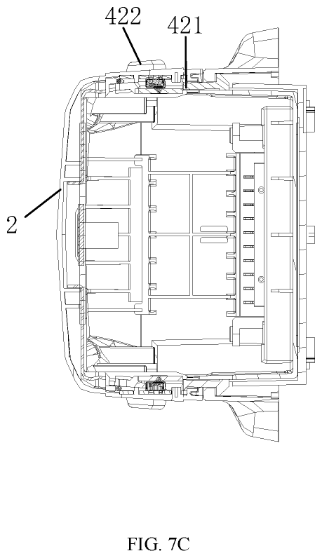

In some embodiments, as shown in FIGS. 5A-5C, when the battery assembly 10 is not yet mounted to the autonomous movable platform, the compressing piece 423 compresses the switch 32, and the switch 32 may be in the first status. At this point, the in-position signal corresponds to the first level. When the battery assembly 10 needs to be mounted to the autonomous movable platform, an external force may be applied to the compressing member 422. For example, a hand of a user may press the compressing member 422 to apply a pressing force on the compressing member 422 facing inside of the housing 2 of the battery assembly 10. With the force, the snap clip 421, the connection plate 424, and the compressing piece 423 as a whole may be driven to move inward relative to the housing 2. For the battery assembly 10 during a mounting process shown in FIGS. 6A-6C, the compressing piece 423 no longer compresses the switch 32 and the switch 32 is released, and the switch 32 may be in the second status. At this point, the in-position signal may correspond to the second level. As the battery assembly 10 mounted in position at the autonomous movable platform shown in FIGS. 7A-7C, the external force may be removed, that is, the hand of the user releases the compressing member 422 and does not apply the pressing force to the compressing member 422. The snap clip member 42 as a whole may have the elasticity relative to the fixing member 41. The snap clip 421 is snapped and connected to a corresponding structure of the autonomous movable platform to fix the battery assembly 10 at the autonomous movable platform. Thus, the snap clip 421, the compressing piece 423, and the connection plate 424 as a whole may move outward relative to the housing 2, and the compressing piece 423 may return to the status of compressing the switch 32. Therefore, the switch 32 may also return to the first status, and the in-position signal may return from the second level to the first level again. The autonomous movable platform may sense whether the battery assembly 10 is mounted in position by detecting the in-position signal. For example, if the in-position signal is detected to be at the first level, the battery assembly 10 may be determined to be mounted in position. If the in-position signal is detected to be at the second level, the user may be prompted to check whether the battery assembly is mounted in position.

The battery assembly 10 consistent with embodiments of the present disclosure cooperates with the snap clip assembly 4. The snap clip assembly 4 is configured to mount the battery. The switch assembly 3 is arranged at the battery assembly 10. The switch assembly 3 may be configured to output the in-position signal. The system may determine whether the battery assembly 10 is mounted in position through the in-position signal. As such, the battery assembly 10 may be ensured to be mounted in position during the operation of the autonomous movable platform, which may effectively prevent the risk of the battery powering off and even falling off of the autonomous movable platform due to unable to determine the mounting status of the battery assembly 10. Thus, the safety of the autonomous movable platform may be improved.

In some embodiments, the first level may be a high-level, and the second level may be a low-level, or the first level may be low-level, and the second level may be high-level. As shown in FIG. 2, a number of the switch assemblies and a number of the snap clip assemblies both are two. The two switch assemblies are fixed at inner walls of two opposite side plates, respectively. The two snap clip assemblies may be configured to compress and release the corresponding switch assemblies, respectively. Compared to only arranging one switch assembly and one snap clip assembly, arranging the switch assemblies and the snap clip assemblies at the inner walls of the two opposite side plates may ensure that the battery assembly 10 is completely mounted in position at the autonomous movable platform. That is, the situation that one side of the battery assembly 10 is mounted in position but the other side of the battery assembly 10 is not mounted in position may not occur. Thus, the safety of the autonomous movable platform may be further improved.

The battery assembly 10 further includes a lightboard 24. The lightboard 24 is accommodated in the housing 2 and is electrically connected to the motherboard 26. The lightboard 24 is fixedly arranged at the bottom plate 21. In some embodiments, the lightboard 24 may be fixed at the bottom plate 21 by screws or adhesive. A second mounting member 212 is arranged at the bottom plate 21 and is configured to fix the lightboard 24 at the bottom plate 21. The second mounting member 212 may be a threaded hole. A battery switch is further arranged at the housing 2 of the battery assembly 10. As shown in FIG. 5A, the battery switch 8 includes a switch button 81 and a display 82. The battery switch 8, for example, is arranged at back of the bottom plate 21 of the housing, that is, facing away from the surface of the accommodation chamber 23. The battery body 1 is electrically connected to the motherboard 26 through the switch button 81 and the flexible circuit board 25. The motherboard 26 may control a power supply status of the battery body 1 according to the on/off status of the switch button 81. The battery assembly 10 may be turned on or off by pressing the switch button 81. The display 82 is fixed at the bottom plate 21 of the housing. The display 82 may include a semi-transparent or transparent material, for example, a semi-transparent or transparent ring around the switch button 81. An indicator may be located at the lightboard 24, may correspond to the position of the display 82 of the battery switch 8, and may be electrically connected to the motherboard 26. The motherboard 26 may be configured to detect the power of the battery body 1. The indicator may be configured to display the power of the battery body 1. The power of the battery body 1 may be known by viewing an indicating status of the indicator through the ring. For example, if the whole ring is lit up, the power of the battery body 1 may be full, and if ¾ of the ring is lit up, the remaining power of the battery body 1 may be 75%. In some embodiments, the indicator may also indicate an in-position situation of the battery assembly. For example, when the battery assembly is mounted in position, the indicator may display normally. When the battery assembly is not mounted in position, red light of the indicator may flash quickly.

In some other embodiments, the battery assembly 10 may have same or similar features as above embodiments, which are not repeated. Only features different from above embodiments are described in detail.

As the battery assembly 10 consistent with embodiments of the present disclosure, the snap clip 421 may be pre-compressed at a predetermined angle toward the outside of the housing 2 to cause the compressing piece 423 to compress the switch 32. When the compressing piece 423 compresses the switch 32, the compressing piece 423 may be parallel to the circuit board 31 of the switch assembly.

In some embodiments, when the battery assembly 10 is not mounted at the autonomous movable platform and is mounted in position at the autonomous movable platform, the snap clip 421 may pre-compress to the pre-determined angle toward the outside of the housing 2, and the compressing piece 423 is parallel to the circuit board 31. As such, the force may be increased for the compressing piece 423 to compress the switch 32 to cause the compressing piece 423 to compress the switch 32 more sufficiently. As such, the switch 32 may be ensured to be in the first status, and the autonomous movable platform may detect the first level, which is beneficial to improve the safety of the autonomous movable platform. The predetermined angle may be selected as needed, for example, 5°.

In some other embodiments, the battery assembly 10 may have same or similar features as above embodiments, which are not repeated. Only features different from above embodiments are described in detail.

As the battery assembly 10 of embodiments of the present disclosure, the switch assembly 3 may not be fixed at the inner wall of the housing 2 but fixed at an outer wall of the housing 2 or at the snap clip assembly 4. The circuit board 31 of the switch assembly may be fixed at the outer wall or the snap clip assembly 4 of the housing 2 by but not limited to the screws, adhesive, etc.

As the battery assembly 10 is not mounted at the autonomous movable platform, the switch 32 may not be compressed, and the switch 32 may be in the first status. At this point, the in-position signal of the switch 32 may be maintained at the first level. During the process of mounting the battery assembly 10 at the autonomous movable platform, the switch 32 may be in the second status due to the compression of the autonomous movable platform. At this point, the in-position signal generated by the switch 32 may change to the second level. When the battery assembly 10 is mounted in position at the autonomous movable platform, the external force applied at the switch 32 may be removed, and the switch 32 may be released and no longer compressed by the battery body 1. Thus, the switch 32 may return to the first status, and the in-position signal may return from the second level back to the first level. The autonomous movable platform may sense whether the battery assembly 10 is mounted in position by detecting the status of the in-position signal.

Similar to above embodiments, the switch assembly 3 may be caused to output the in-position signal through the battery body 1 compressing or releasing the switch assembly 3. The battery assembly 10 of embodiments of the present disclosure may determine whether the battery assembly 10 is mounted in position through the in-position signal, which may ensure that the battery assembly 10 is mounted in position during the operation of the autonomous movable platform. As such, the risk of the battery powering off even falling off of the autonomous movable platform may be effectively prevented due to unable to determine the mounting status of the battery assembly 10, which is beneficial to improve the safety of the autonomous movable platform.

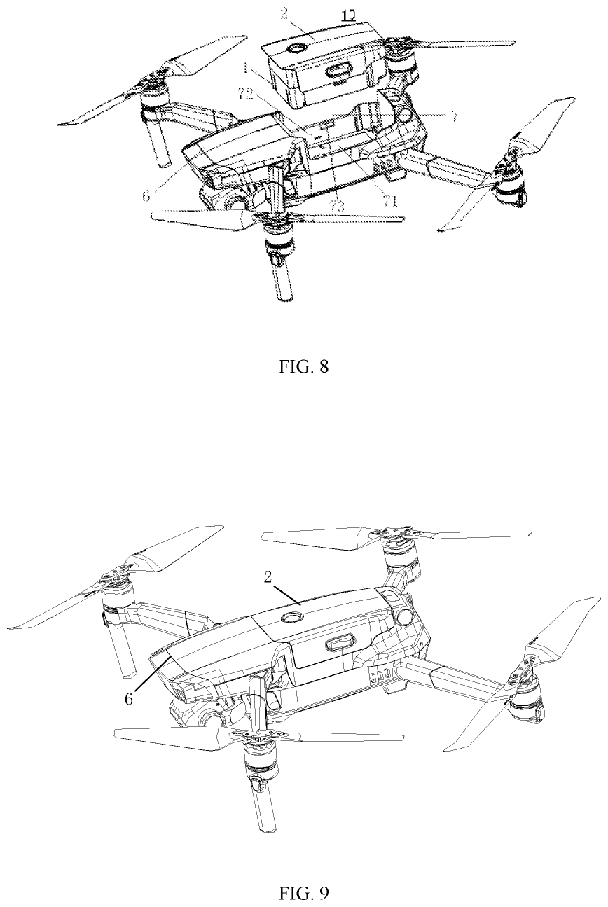

In some other embodiments, an autonomous movable platform is provided, which may move under the control of the control terminal. As shown in FIG. 8, for example, the autonomous movable platform includes a UAV, which includes a vehicle body 6. A plurality of arms and a gimbal are arranged at the vehicle body 6. An end of each arm is arranged with a propeller. The gimbal is configured to mount an onboard device. The vehicle body 6 includes a battery compartment 7 and a control system accommodated in the vehicle body 6. The battery compartment 7 is be configured to accommodate the battery assembly 10. The battery assembly 10 may include the battery assembly 10 of any above embodiments. The control system may be configured to control the operation of the autonomous movable platform.

The battery compartment 7 is formed and enclosed by a bottom wall 71 and four side walls 72. A snap slot 73 is arranged at the sidewall 72. The snap slot 73 is arranged correspondingly to a snap hook 4211 of the battery assembly 10. An input terminal may be arranged at the bottom wall 71. The input terminal may be arranged correspondingly to the output terminal 5 of the battery assembly 10.

The snap slot 73 may be snapped and connected to the snap hook 4211 of the battery assembly 10 to fix the battery assembly 10 in the battery compartment 7. The input terminal may be connected to the output terminal 5 of the battery assembly 10 to transmit the power of the battery body land the in-position signal to the control system. The input terminal may use a connector that is electrically connected to the connector of the output terminal 5 of the battery assembly 10.

In the UAV consistent with embodiments of the present disclosure, as the battery assembly 10 with the switch assembly 3 fixed to the inner wall of the housing 2 when the battery assembly 10 is inserted into the battery compartment 7, the external force (e.g., the hand of the user presses the compressing member 422) may be acted on the compressing member 422 to apply a pressing force to the compressing member 422. Under the pressing force, the snap clip 421, the connection plate 424, and the compressing piece 423 as a whole may be driven to move inward relative to the housing 2. Thus, during the whole process of inserting the battery assembly 10 into the battery compartment 7, the compressing piece 423 may no longer compress the switch 32 and may release the switch 32. At this point, the in-position signal may change to the second level. As shown in FIG. 9, when the battery assembly 10 is mounted in position in the battery compartment 7, the output terminal 5 of the battery assembly 10 is electrically connected to the input terminal. The hand of the user may release the compressing member 422 and no longer apply the pressing force to the compressing member 422. Since the whole snap clip member 42 has the elasticity relative to the fixing member 41, the snap clip 421, the connection plate 421, and the compressing piece 423 as a whole may move outward relative to the housing 2. The compressing piece 423 may return to the status of compressing the switch 32, and the in-position signal may return from the second level to the first level.

As the battery assembly 10 with the switch assembly 3 fixed at the outer wall of the housing 2 or at the snap clip assembly 4, the battery compartment 7 includes an accommodation slot for accommodating the switch 32. After the battery assembly 10 is mounted in position, the accommodation slot may just accommodate the switch 32. When the battery assembly 10 is inserted into the battery compartment 7, the battery compartment 7 may cause the switch 32 to be compressed, and the in-position signal may be changed to the second level. When the battery assembly 10 is mounted in position in the battery compartment 7, the output terminal 5 of the battery assembly 10 may be electrically connected to the input terminal, and the switch 32 and the accommodation slot are snaped and connected. The switch 32 may no longer be compressed by the battery compartment, and the in-position signal may return from the second level to the first level again.

After the battery assembly 10 is powered on, the battery assembly 10 may start to supply power to the UAV. When the control system detects that the in-position signal is the first level, the control system may transmit a first feedback signal to the control terminal to notify the control terminal that the battery assembly 10 is mounted in position and the autonomous movable platform may operate normally. When the control system detects that the in-position signal is at the second level, the control system may transmit a second feedback signal to the control terminal to notify the control terminal that the battery assembly 10 is not mounted in position and prompt the user to check the mounting of the battery assembly 10. The autonomous movable platform of embodiments of the present disclosure may include but be not limited to the UAV, the unmanned vehicle, etc.

The autonomous movable platform consistent with embodiments of the present disclosure may determine whether the battery assembly is mounted in position by detecting the in-position signal. As such, the autonomous movable platform may be ensured to operate only after the battery assembly is mounted in position, and the risk of the battery powering off even falling off of the autonomous movable platform may be effectively prevented due to unable to determine the mounting status of the battery assembly. Thus, the safety of the autonomous movable platform may be improved.

Embodiments of the present disclosure further provide an autonomous movable platform system, which includes the autonomous movable platform and the control terminal. The autonomous movable platform may use the autonomous movable platform of above embodiments. The control terminal may ensure that the autonomous movable platform may start only after the battery assembly is mounted in position according to the feedback signal of the control system. As such, the risk of the battery powering off even falling off of the autonomous movable platform may be effectively prevented due to unable to determine the mounting status of the battery assembly. Thus, the safety of the autonomous movable platform may be improved.

Those skilled in the art may understand that, for the convenience and conciseness of the description, only the division of the above-mentioned functional modules is described as an example. In practical applications, the above-mentioned functions may be allocated by different functional modules as needed. That is, an internal structure of the device may be divided into different functional modules to complete all or some functions described above. For the specific operation process of the device described above, reference may be made to the corresponding process in above method embodiments, which is not repeated here.

Finally, above embodiments are only used to illustrate the technical solutions of the present disclosure, but not to limit them. Although the present disclosure has been described in detail with reference to above embodiments, those of ordinary skill in the art should understand that modifications may still be made to the technical solutions described in above embodiments, or the equivalent replacements may be made to some or all the technical features. When there is no conflict, the features of embodiments of the present disclosure can be combined arbitrarily. All these modifications or replacements do not cause the essence of the corresponding technical solutions to depart from the scope of embodiments of the present disclosure.

What is claimed is:

1. A battery assembly comprising:
a battery body;
a housing including an accommodation chamber, the battery body being mounted in the accommodation chamber;
a switch assembly fixed at the housing and configured to generate an in-position signal;
an output terminal arranged at the housing and configured to output power of the battery body and the in-position signal; and
a snap clip assembly arranged at the housing and configured to:
cause the switch assembly to be in a first status when no external force is applied to the snap clip assembly, the in-position signal being at a first level in the first status; and
in response to an external force applied to the snap clip assembly, cause the switch assembly to be in a second status, the in-position signal being at a second level in the second status.

2. The battery assembly of claim 1, wherein the second status is opposite to the first status.

3. The battery assembly of claim 1, wherein:
the housing includes a bottom plate and four side plates, the bottom plate and the four side plates enclosing to form the accommodation chamber;
the switch assembly is one of two switch assemblies of the battery assembly and the snap clip assembly is one of two snap clip assemblies of the battery assembly; and
the two switch assemblies are fixed at inner walls of two opposite ones of the side plates, respectively.

4. The battery assembly of claim 1, wherein:
the housing includes a bottom plate and four side plates, the bottom plate and the four side plates enclosing to form the accommodation chamber;
the switch assembly includes:
a circuit board fixed at an inner wall of one of the side plates; and
a switch located at the circuit board and configured to generate the in-position signal;
the snap clip assembly includes:
a fixing member fixed at the bottom plate;
a snap clip member configured to move relative to the fixing member to cause the switch to be in the first status or the second status; and
a connector connecting between the fixing member and the snap clip member to cause the snap clip member to move relative to the fixing member.

5. The battery assembly of claim 4, wherein the snap clip member includes:
a snap clip connected to the fixing member; and
a compressing piece connected to the snap clip and configured to cause the switch to be in the first status or the second status, the compressing piece being parallel to the circuit board when the switch is in the first status.

6. The battery assembly of claim 5, wherein in the first status, the switch is compressed, and the snap clip is pre-compressed toward outside of the housing for a predetermined angle to cause the compressing piece to compress the switch.

7. The battery assembly of claim 5, wherein:
the snap clip member further includes a compressing member arranged at the snap clip;
the housing further includes an opening formed at one of the side plates, the opening being arranged corresponding to the compressing member and being configured for the compressing member to pass through;
in response to the external force being applied to the compressing member, the snap clip moves inward relative to the housing, and the switch is in the second status; and
in response to the external force applied to the compressing member being removed, the snap clip moves outward relative to the housing, and the switch is in the first status.

8. The battery assembly of claim 7, wherein:
a bottom end of the snap clip is connected to the fixing member;
a top end of the snap clip includes a snap hook; and
a height of the snap clip is higher than a height of the side plate of the housing.

9. The battery assembly of claim 4, wherein a material of the fixing member includes a metal.

10. The battery assembly of claim 4, wherein a material of the snap clip member includes plastic.

11. The battery assembly of claim 4, wherein the connector is a metallic structure.

12. The battery assembly of claim 4, wherein the connector and the fixing member are formed integrally.

13. The battery assembly of claim 1, wherein the first level is one of high-level and low-level, and the second level is another one of the high-level and the low-level.

14. The battery assembly of claim 1, further comprising:
a motherboard arranged at the housing, the battery body being configured to be electrically connected to the motherboard, the motherboard being configured to be electrically connected to the switch assembly and the output terminal and transmit the in-position signal to the output terminal.

15. The battery assembly of claim 14, further comprising:
a battery switch arranged at the housing, electrically connected to the motherboard, and configured to control on and off of the battery body.

16. The battery assembly of claim 15,
wherein the battery switch includes a switch button and a display, the switch button being configured to control the on and off of the battery body;
the battery assembly further comprising:
a lightboard electrically connected to the motherboard; and
an indicator arranged at the lightboard, corresponding to a position of a display, and configured to display at least one of a power of the battery body or the in-position signal.

17. An autonomous movable platform comprising a platform body including:
a battery compartment configured to accommodate a battery assembly including:
a battery body;
a housing including an accommodation chamber, the battery body being mounted in the accommodation chamber;
a switch assembly fixed at the housing and configured to generate an in-position signal;
an output terminal arranged at the housing and configured to output power of the battery body and the in-position signal; and a snap clip assembly arranged at the housing and configured to:
cause the switch assembly to be in a first status when no external force is applied to the snap clip assembly, the in-position signal being at a first level in the first status; and
in response to an external force applied to the snap clip assembly, cause the switch assembly to be in a second status, the in-position signal being at a second level in the second status.

18. The autonomous movable platform of claim 17, further comprising:
a control system;
wherein the battery compartment includes:
a snap slot configured to be snapped and connected to the snap clip assembly of the battery assembly to fix the battery assembly in the battery compartment; and
an input terminal configured to be connected to the output terminal of the battery assembly to transmit power of the battery body and the in-position signal to the control system.

19. The autonomous movable platform of claim 18, wherein:
in response to the external force being applied to the snap clip assembly when the battery assembly is being inserted in the battery compartment, the in-position signal changes to the second level;
after the battery assembly is accommodated in the battery compartment and the output terminal of the battery assembly is electrically connected to the input terminal, in response to the external force being removed, the snap clip assembly of the battery assembly is snapped and connected to the snap slot and the in-position signal returns to the first level; and
the control system is configured to, after being powered on:
in response to detecting that the in-position signal is the first level, transmit a first feedback signal to a control terminal; and
in response to detecting that the in-position signal is the second level, transmit a second feedback signal to the control terminal.

20. An autonomous movable platform system comprising:
a control terminal; and
an autonomous movable platform including a platform body, the platform body including:
a battery compartment configured to accommodate a battery assembly including:
a battery body;
a housing including an accommodation chamber, the battery body being mounted in the accommodation chamber;
a switch assembly fixed at the housing and configured to generate an in-position signal;
an output terminal arranged at the housing and configured to output power of the battery body and the in-position signal; and
a snap clip assembly arranged at the housing and configured to:
cause the switch assembly to be in a first status when no external force is applied to the snap clip assembly, the in-position signal being at a first level in the first status; and
in response to an external force applied to the snap clip assembly, cause the switch assembly to be in a second status, the in-position signal being at a second level in the second status.
